(19) United States
(12) Patent Application Publication
(10) Pub. No.: US 2003/0042419 A1
(43) Pub. Date: Mar. 6, 2003

(54) Method and apparatus for detecting a wafer's posture on a susceptor

(76) Inventors: Hirohumi Katsumata, Fuji-shi (JP); Takehiko Kobayashi, Sunto-gun (JP)

Correspondence Address: PILLSBURY WINTHROP LLP, 1600 TYSONS BOULEVARD, MCLEAN, VA, 22102, US

(21) Appl. No.: 09/740,030

(22) Filed: Dec. 20, 2000

(30) Foreign Application Priority Data
Dec. 21, 1999 (JP) 11-362911

(51) Int. Cl. G01J 5/02

(52) U.S. Cl. 250/339.11

(57) ABSTRACT

An apparatus used for an epitaxial vapor growing arrangement and for detecting whether a wafer is properly seated within a susceptor contained therein. The apparatus includes a semiconductor laser element that generates a laser beam which irradiates the wafer's surface. The apparatus, further, includes a combination of a stop mechanism, a condenser lens and a photo diode, which detects the laser beam reflected from the wafer surface and an operation circuit, which determines the wafer's posture on the susceptor. During operation, the reflected laser beam focuses on a receiving surface of the photo diode through the condenser lens. The operation circuit then compares the output signal from the photo diode with a preset reference value for discriminating the slope of the wafer.

### BACKGROUND OF THE INVENTION

1. Field of the Invention

This invention relates to an epitaxial vapor growing device for manufacturing semiconductor waters, and more particularly, to an apparatus for detecting and adjusting the position of a semiconductor wafer positioned on a susceptor within the epitaxial vapor growing device.

2. Description of Related Art

FIG. 5 shows a conventional epitaxial vapor growing device typically used to manufacturing semiconductor wafers by depositing a thin layer of silicon onto the surface of the wafer.

In FIG. 5, a reaction chamber 2 includes a susceptor 3, located approximately in the center of the reaction chamber, to support a wafer 1 thereon. The shape of the susceptor 3 may resemble a ring, which is fixedly mounted on a hollow bearer 4 and connected to a motor drive unit (not shown) so as to rotate the susceptor 3.

The hollow bearer 4 includes a fixed column 31 supporting a table 32. Mounted onto the table 32 are a disc like heater 6 and a ring like heater 7, located at the circumference of the heater 6. The heater 6 radiates heat toward the bottom surface of the wafer 1, and the heater 7 radiates heat toward the bottom surfaces of the susceptor 3. The column 31 is stationary so that it does not turn with the rotation of the suspector 3.

A nozzle mounted on the center of a ceiling plate 2a, as shown in FIG. 5, introduces a reaction gas into the reaction chamber 2. As indicated by the arrows in FIG. 5, the reaction gas initially flows near the central portion of the wafer 1. Next, the gases flows in an direction outwardly along the surface of the wafer 1. Then, the reaction gas flows downwardly along the inside wall of the reaction chamber 2 and exits through an outlet 9. Provided on the ceiling plate 2a are radiation pyrometers 11, 12 for detecting the surface temperatures of the wafer 1. The pyrometer 11 detects the surface temperature of the central portion of the wafer 1, and the pyrometer 12 detects the surface temperature of the circumference of the wafer 1. The detected surface wafer temperatures are used as feedback signals for controlling the temperature of the wafer. Because the rotation of the wafer 1 causes the growth rate of the thin silicon layer to increase through the exchange of the reaction gases on the surface of the wafer 1, an improved uniform thickness of the thin silicon layer may be achieved by maintaining the surface of the wafer at a constant temperature.

Nevertheless, the conventional devices suffer from several disadvantages. Usually, the equipment used to manufacture semiconductors is highly automated. For example, a robot hand or fork is often employed to automatically convey the wafer 1 to and retrieve the wafer 1 from the vapor growing device.

However, because an error may develop within the position control mechanism of the robot's hand or fork, the robot may not correctly position the wafer 1 within a step formed on the upper, inside surface of the ring of the susceptor 3. In other words, a portion of the circumference of the wafer 1 may be misaligned so as to lie upon the step so that the wafer posture is sloped instead of flat.

In such a case, when the vapor growing process begins on a wafer that is misaligned on the susceptor 3, the reaction gases do not flow downwardly in a symmetrical and uniform manner. As the result, the uniform thickness and the quality of the thin silicon layer deposited on the wafer's surface deteriorates.

Furthermore, when the device rotates a misaligned wafer, the wafer 1 may become dislodged from the susceptor 3 as the rotational speed increases causing damage to the wafer 1 and to the components of and the interior surface of the reaction chambers.

The present invention addresses the various drawbacks mentioned above. Therefore, it is an object of the present invention to provide an apparatus for determining whether or not a wafer is correctly positioned within a step formed on a susceptor.

### SUMMARY OF THE INVENTION

The invention relates to an apparatus for detecting the posture of a wafer positioned on a susceptor which includes a step formed thereon. A light beam source generated at the top of the apparatus irradiates a light beam downwardly onto the surface of the wafer positioned on the susceptor. The apparatus produces an electric signal with respect to the light beam reflected on the wafer surface so that a determination can be made as to whether or not the wafer is correctly seated in the step of the susceptor based on the electrical signal.

In the embodiment described above, a laser beam may be used as the light beam, a photo sensitive detector may be used to produce the electric signal with respect to the light beam reflected on the wafer surface, and a comparator may be used to determine the alignment of the wafer's posture.

The procedure for detecting the wafer's posture is as follows:

However, before the detection operation begins, the following adjusting (a) and storing (b) processes are necessary.

(a) Initially, the device performs a self-calibration by adjusting the optical axis of the photo sensitive detector so that the laser beam reflected from the wafer's surface reaches the photo sensitive detector from an angle of a hypothetical wafer correctly positioned within the step.

(b) Then, the device stores the output signal of the photo sensitive detector as a reference signal in a memory.

After the device completes the adjusting and storing processes, the device begins the detection operation.

(c) In a case where a portion of the circumference of the wafer is positioned along the step, this misalignment causes the surface of the wafer to slope slightly along the horizontal plane. As a result, the photo sensitive detector receives the laser beam reflected from the wafer surface at a fixed receiving area in accordance with an angle that corresponds to the degree of slope of the wafer.

(d) Then, the system compares the output of the photo sensitive detector with the reference signal determined in the above process (b), and, if a difference exists, the wafer is not correctly positioned on the susceptor.

The stop mechanism including an adjustable aperture may be located in front of the photo sensitive detector. The stop mechanism may be used to limit the quantity of an incident laser beam focused at the receiving area may be limited. In such an arrangement, it is possible to close the aperture so that no incident laser beam reaches the receiving area when the wafer's slope exceeds a predetermined degree. Therefore, the stop mechanism increases the accuracy of determining the wafer's posture or slope.

In the above apparatus, instead of detecting the reflected light beam's quantity, a plurality of photo sensitive element such as charge coupled device (CCD) may be used to detect the position to which the reflected light beam reaches the photo sensitive element. The CCD enables the device to determine the wafer's slope based on the detected position. Furthermore, an aperture adjustable stop located in front of the CCD may be adjusted so as to focus and limit the incident light beam to a particular area of the CCD.

### BRIEF DESCRIPTION OF THE DRAWINGS

The above and other objects, features and advantages of the present invention are further described in the detailed description which follows, with reference to the drawings by way of non-limiting exemplary embodiments of the present invention. It is noted that, throughout the description, like reference numerals represent similar parts of the present invention throughout the several views and wherein:

FIG. 1 is an arrangement of an epitaxial vapor growing apparatus showing the embodiment according to the invention.

FIG. 2 is an outline block diagram of detecting apparatus according to the invention.

FIG. 3 is an enlarged sectional view showing a wafer correctly positioned within a step on a susceptor and a laser beam projected onto the wafer.

FIG. 4 is an enlarged sectional view showing a misaligned wafer positioned on a step on an susceptor and a laser beam on projected onto the wafer.

FIG. 5 is an arrangement of an epitaxial vapor growing apparatus according to a conventional apparatus.

### DETAILED DESCRIPTION OF THE EMBODIMENT

The embodiment according to the invention will be explained below with reference to the attached drawings.

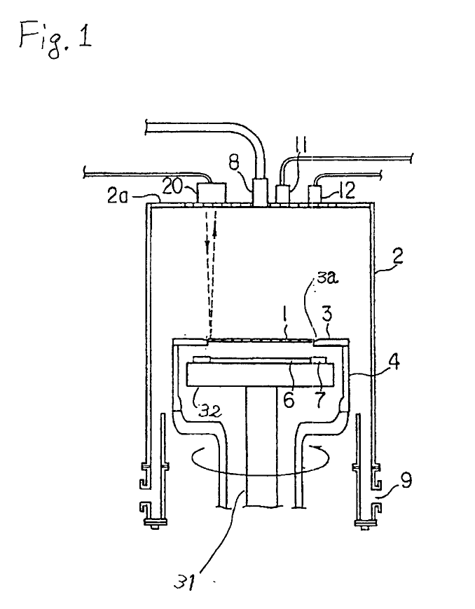

FIG. 1 shows an epitaxial vapor growing device on which an apparatus for detecting the posture of a wafer positioned on a susceptor. FIG. 1 illustrates a detection head 20 for a wafer posture which includes a source for emitting a laser beam and a detector for receiving the reflected laser beam. The detection head 20 mounts onto the ceiling 2a of a reaction chamber 2, and the detection head 20 directs its laser beam through a window mounted on ceiling 2a to the circumference of the wafer 1.

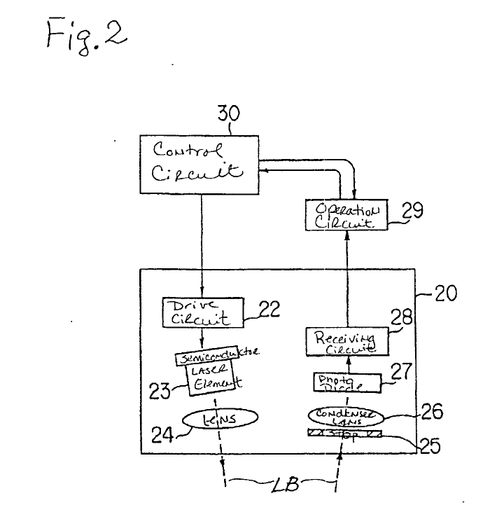

FIG. 2 shows an outline of the apparatus for detecting the wafer's posture according to this embodiment. In FIG. 2, the detection head 20 contains a drive circuit 22, an semiconductor laser element 23 for generating a laser, a len 24 for irradiating a laser beam, a stop mechanism 25, condenser lens 26, a photo diode 27 and a receiving circuit 28.

In response to an instruction received from a control circuit 30, the drive circuit 22 supplies a voltage signal to the laser element 23 to emit a laser beam towards the surface of the wafer 1. Since the wafer 1 has a mirror-like surface, the wafer 1 reflects the incident laser beam with total reflection without any diffusion.

The reflected laser beam passes through the stop mechanism 25 and enters into the condenser lens 26 so that the reflected laser beam focuses on the surface of the photo diode 27. The output signal of the photo diode 27 travels through the receiving circuit 28 to an operation circuit 29, which determines whether the wafer 1 is correctly positioned horizontally on a susceptor 2 or positioned incorrectly with a slope.

If the operation circuit 29 determines that the position of the wafer is incorrect, the operation circuit 29 sends an alarm signal to the control circuit 30. In accordance with the alarm signal, the control circuit 30 instructs the operation circuit 29 to terminate the operation of the vapor growing apparatus and to sound a warning bell. Furthermore, the control circuit 30 instructs a hand of a robot (not shown) to reposition the wafer 1 on the susceptor.

The process of the detecting apparatus is as follows:

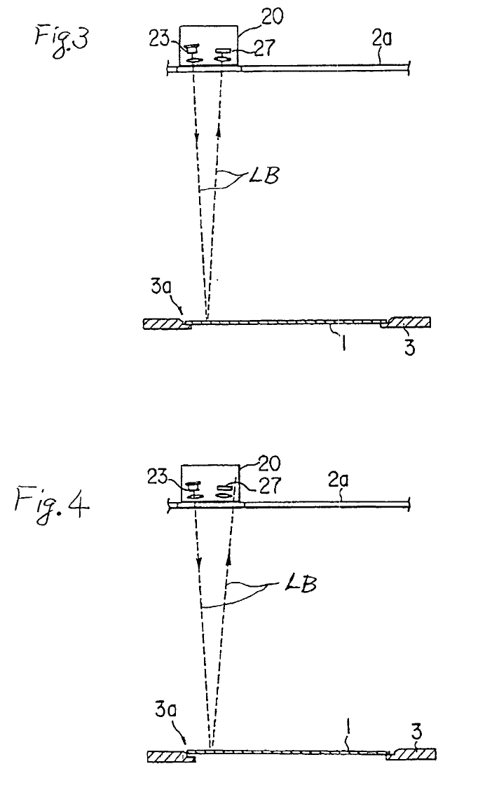

Initially, as shown in FIG. 3, the device performs the adjusting process by performing a self-calibration as if the step 3a contained a properly seated wafer. A photo diode 27, containing an optical axis positioned therein, may serve as a photo sensitive detector. The laser element 23, stop mechanism 25 and condenser lens 26 are aligned so that the laser beam reflected from the wafer's surface has an incident angle which is projected onto the center of the condenser lens 26 and is focused on the receiving surface of the photo diode 27. While maintaining these conditions, the device measures the output signal of photo diode 27 and stores it into the memory as a reference signal.

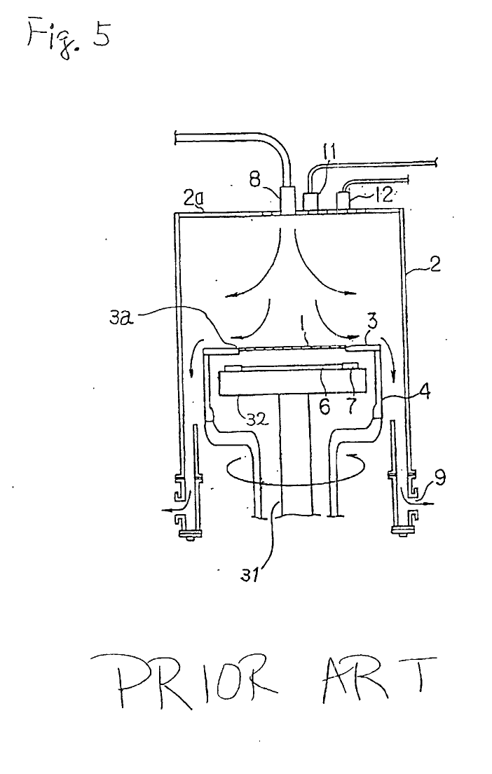

Next, as shown in FIG. 4, the device simulates the misaligned slope operation several times in order to measure and store various reference output signals of the photo diode 27 in a misaligned state. This step enables the device to gather numerous predetermined reference angles of a misaligned wafer I sloped so that the wafer 1 is positioned on the step 3a, as portrayed in FIG. 4. These predetermined misaligned reference angles are stored in the memory based on the output signals of the photo diode 27.

The stop mechanism 25 may be mounted in front of the photo diode 27 so that the sensitivity of the output signal to the wafer's slope is adjustable by changing the aperture of stop 25 to limit the exposed receiving area of the photo diode 27 on which the incident laser beam LB focuses. In cases where the stop mechanism 25 has been adjusted to contain narrow openings or aperture, the slope of the wafer surface may block the incident laser beam from entering into the condenser lens 26, thus, greatly reducing the output of the photo diode 27. In contrast, when the stop mechanism 25 contains wide openings or aperture, the output signal of the photo diode 27, which corresponds to the wafer's slope changes only slightly, and the output signal of the photo diode 27 changes only when the slope exceeds a predetermined range.

Consequently, the process of determining the accuracy of the wafer's slope on the susceptor 3 may be improved by properly adjusting the settings of the openings of the stop mechanism 25.

Furthermore, when the system adjusts the optical axis between the condenser lens 26 and the photo diode 27 during the preparation process, the accuracy of adjusting the optical axis may be enhanced by setting the openings of the stop mechanism 25 to a minimum level.

Detection of the wafer's slope may be performed while the wafer 1 rotates or while the wafer is stationary. In case of the former, the determination of the slope may be performed based on a mean values of a points selected and sampled during one rotation of the wafer 1 or based on a value integrated by using an integration circuit (not shown).

According to the present invention, a determination as to whether or not the wafer is correctly positioned within the step of the susceptor may be accurately performed, thereby preventing the wafer from being deposited at angle and improving the yield rate of the wafer.

While embodiments of the present invention have been described using specific terms, such description is for illustrative purpose, and it is to be understood that changes and variations may be made without departing from the spirit or scope of the following claims.

What is claimed is:

1. An apparatus comprising:
a wafer positioned on a susceptor including a step;
a light beam source for irradiating a light beam to a surface of said wafer;
an electric signal mechanism for producing an electric signal with respect to said light beam reflected onto said wafer's surface; and
a detection mechanism for detecting whether said wafer is correctly positioned within said step of said susceptor based upon said electrical signal.

2. The apparatus as according to claim 1, wherein said light beam source is a laser beam.

3. The apparatus as according to claim 1 or 2 wherein said electrical signal mechanism is a photo-sensitive element installed within said apparatus so as to receive the reflected light beam quantity in accordance with a slope of said wafer's surface.

4. The apparatus as according to claim 1 or 2 wherein said electrical signal mechanism is a plurality of photo sensitive elements arranged in a plane perpendicular to an optical axis of the light beam so as to detect a position of the plane to which the reflected light beam reaches.

5. The apparatus as according to claim 3, wherein said electrical signal mechanism further contains an adjustable aperture installed in front of said photo-sensitive element.

6. The apparatus as according to claim 4, wherein said electrical signal mechanism further contains an adjustable aperture installed in front of said photo-sensitive element.

7. The apparatus as according to claim 3, wherein said electrical signal mechanism further contains a condenser lens in front of said photo sensitive element.
